(19) United States
(12) Patent Application Publication
(10) Pub. No.: US 2024/0346696 A1
(43) Pub. Date: Oct. 17, 2024

(54) IMAGE PROCESSING METHOD AND APPARATUS, AND STORAGE MEDIUM

(71) Applicant: SZ DJI TECHNOLOGY CO., LTD., Shenzhen (CN)

(72) Inventors: Zhangyu YE, Shenzhen (CN); Xinchao QU, Shenzhen (CN)

(21) Appl. No.: 18/752,470

(22) Filed: Jun. 24, 2024

Related U.S. Application Data
(63) Continuation of application No. PCT/CN2021/141313, filed on Dec. 24, 2021.

(51) Int. Cl. G06T 7/90

(52) U.S. Cl. CPC G06T 7/90; G06T 2207/10024; G06T 2207/20076

(57) ABSTRACT

An image processing method includes obtaining a to-be-processed image, obtaining a target image based on the to-be-processed image, and outputting the target image. The to-be-processed image has been subjected to white balance correction. Obtaining the target image based on the to-be-processed image includes determining a G channel value of a first pixel in the target image based on an R channel value and a B channel value of a second pixel in the to-be-processed image, the first pixel and the second pixel being at a same pixel position.

### CROSS-REFERENCE TO RELATED APPLICATION

This application is a continuation of International Application No. PCT/CN2021/141313, filed Dec. 24, 2021, the entire content of which is incorporated herein by reference.

### TECHNICAL FIELD

The present disclosure relates to the image processing technology field and, more particularly, to an image processing method, an imaging processing apparatus, and a storage medium.

### BACKGROUND

Generally, in an image, a signal in a G channel is often stronger than signals in an R channel and a B channel. Therefore, during white balance correction, to restore a white color in the image to white, a determined G channel white balance gain is usually set to 1, and an R channel white balance gain and a B channel white balance gain are often greater than 1. Thus, the R channel value and the B channel value are greater than a saturation pixel value (e.g., for an 8-bit image, the saturation pixel value is 255) after the image is white balanced, or the G channel value originally collected is greater than the saturation pixel value. Therefore, after the image is white balanced, the image can be clipped to retain details of the member exceeding the saturation pixel value as much as possible in the subsequent processing. In the related technology, when the G channel value is not saturated, a clipping value is determined based on the G channel value. When the G channel value is saturated, since the G channel value is not the real value, to avoid color distortion after clipping, the G channel value is usually clipped to the saturation pixel value, which avoids the color distortion but results in the serious loss in the details of the highlighted member of the image.

### SUMMARY

In accordance with the disclosure, there is provided an image processing method. The method includes obtaining the to-be-processed image, obtaining a target image based on the to-be-processed image, and outputting the target image. The to-be-processed image has been subjected to white balance correction. A value of a G channel value of a first pixel in the target image is determined based on an value of an R channel value and a value of a B channel value of a second pixel in the to-be-processed image. The first pixel and the second pixel are at a same pixel position. obtaining a to-be-processed image, obtaining a target image based on the to-be-processed image, and outputting the target image. The to-be-processed image has been subjected to white balance correction. Obtaining the target image based on the to-be-processed image includes determining a G channel value of a first pixel in the target image based on an R channel value and a B channel value of a second pixel in the to-be-processed image, the first pixel and the second pixel being at a same pixel position.

Also in accordance with the disclosure, there is provided an image processing apparatus including one or more processors and one or more memories. The one or more memories store a computer program that, when performed by the one or more processors, causes the one or more processors to obtain the to-be-processed image, obtain a target image based on the to-be-processed image, and output the target image. The to-be-processed image has been subjected to white balance correction. A value of a G channel G channel value of a first pixel in the target image is determined based on an value of an R channel R channel value and a value of a B channel value of a second pixel in the to-be-processed image. The first pixel and the second pixel are at a same pixel position. obtaining a to-be-processed image, obtaining a target image based on the to-be-processed image, and outputting the target image. The to-be-processed image has been subjected to white balance correction. Obtaining the target image based on the to-be-processed image includes determining a G channel value of a first pixel in the target image based on an R channel value and a B channel value of a second pixel in the to-be-processed image, the first pixel and the second pixel being at a same pixel position.

Also in accordance with the disclosure, there is provided an image processing method. The method includes obtaining a to-be-processed image, obtaining a target image based on the to-be-processed image, and outputting the target image. The to-be-processed image has been subjected to white balance correction. A G channel value of a pixel in the target image is determined from an R channel value and a B channel value of a pixel at the same pixel position in the target image.

### BRIEF DESCRIPTION OF THE DRAWINGS

FIG. 1 is a schematic flowchart of an image processing method consistent with an embodiment of the present disclosure.

FIG. 2 is a schematic diagram of an image processing method consistent with an embodiment of the present disclosure.

FIG. 3 is a schematic flowchart of an image processing method consistent with an embodiment of the present disclosure.

FIG. 4 is a schematic diagram of a logic structure of an image processing apparatus consistent with an embodiment of the present disclosure.

### DETAILED DESCRIPTION OF THE EMBODIMENTS

The technical solution of embodiments of the present disclosure is described in detail in connection with the accompanying drawings of embodiments of the present disclosure. Described embodiments are some embodiments of the present disclosure not all embodiments of the present disclosure. Based on embodiments of the present disclosure, all other embodiments obtained by those of ordinary skills in the art without creative efforts are within the scope of the present disclosure.

After an image is collected, white balance correction is usually performed on the image. Since a signal of a G channel is generally stronger than signals of an R channel and a Blue channel, during the white balance correction, to restore the white color in the image to white, the determined G channel white balance gain is usually 1, and the R channel white balance gain and the B channel white balance gain are usually greater than 1. Thus, after the white balance correction of the image, the R channel value and the B channel value can be greater than the saturation pixel value (e.g., for an 8-bit color of the image, the saturation pixel value is 255), or the G channel value that is initially collected can be greater than the saturation pixel value. During the subsequent processing of the image, some processes may require that the pixel value of the image does not exceed the saturation pixel value. If the pixel value of the image exceeds the saturation value, the member with the pixel value greater than the saturation pixel value can be clipped to the saturation pixel value (e.g., the pixel value greater than 255 can be directly changed into 255). Thus, a large amount of details can be lost in the image.

To preserve image details as much as possible, after the white balance correction is performed on the image, the image can be clipped. That is, the pixel value of the image that is greater than a certain clipping value can be replaced by the clipping value and then compressed to fall within the saturation pixel value. Then, the subsequent process can be performed. In related technologies, when the G channel value is not saturated, the clipping values of the R channel and the B channel can be adjusted based on the G channel value. Then, any one or more of the R channel value, G channel value, and B channel value that are greater than the clipping value can be replaced by the clipping value to preserve the details of the image as much as possible. For example, assume the G channel value is 0.9, when the R channel value and the B channel value are 1.5, the R channel value and the B channel value can be clipped to 1.2 (i.e., any of the channel values that is greater than 1.2 is replaced by 1.2). However, when the G channel value is saturated, since the signal of the G channel may not be the real signal (e.g., even if the actual signal of the G channel is greater than 255, the signal outputted by the image sensor can be 255). To avoid the color error of the clipped image, the R channel value, G channel value, and B channel value can be clipped to the saturation pixel value. For example, assume that the G channel value is 1, the R channel value and the B channel value are 1.5, the R channel value and the B channel value can be clipped to 1, which can avoid the color error. However, the details of the member with a pixel value exceeding the saturation pixel value can be lost.

Based on this, embodiments of the present disclosure provide an image processing method. Since the R, G, and B channel values have a certain correlation, when the G channel value is saturated in a to-be-processed image, the actual G channel value can be restored based on the R channel value and the B channel value. Thus, the processing can be performed on the members of the image with the pixel values exceeding the saturation pixel value based on the restored actual G channel value. Thus, the color distortion can be avoided when the members with pixel values exceeding the saturation pixel value are clipped, and the details of the highlighted member of the image can be preserved as much as possible.

The image processing method of embodiments of the present disclosure can be executed by an ISP chip of the image collection apparatus or the image can be outputted to a certain device after being collected by the image collection apparatus, and the image processing method can be executed by image processing software of the device.

The image processing method of embodiments of the present disclosure can be used to process the image after the white balance correction to perform the detail restoration and color restoration on the members with the pixel values exceeding the saturation pixel value in the image. For example, the image processing method can be executed by a certain processing module in the ISP chip. The module can be located behind a white balance correction module.

The saturation pixel value of embodiments of the present disclosure can refer to a maximum threshold for the pixel values of the image. For example, when the pixel value of the image is represented by 8-bit, the saturation pixel value can be 255. When the pixel value of the image is represented by 16-bit, the saturation pixel value can be 65535, and so on.

Over-saturation of embodiments of the present disclosure can refer to that the pixel value is greater than the saturation pixel value. The actual G channel value of embodiments of the present disclosure can refer to a pixel value close to the strength of the signal of the G channel in the scene. For example, under a certain scene, the signal of the G channel can be strong, and the actual G channel value can exceed 255 (e.g., 260). However, since the output signal of the image sensor is 255, a value close to the actual signal can be restored based on the values of the R channel and the B channel. The G channel value that is restored based on the values of the R channel and the B channel may not be exactly consistent with the actual signal of the G channel in a practical scene. The color of the over-saturated member can only be approximately restored.

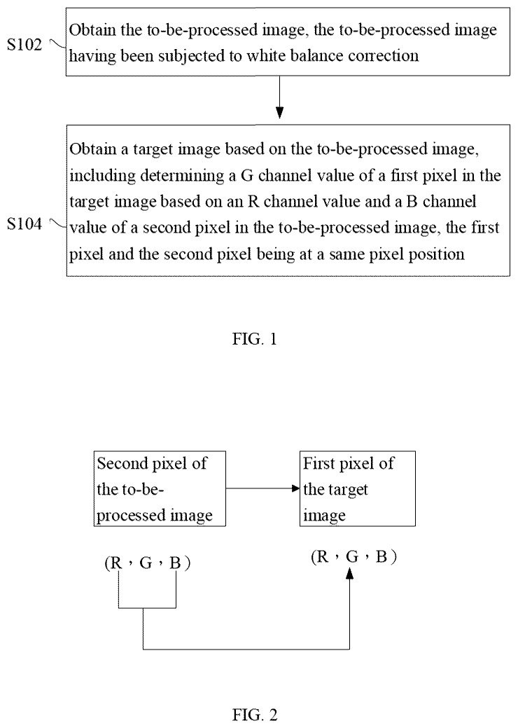

In some embodiments, as shown in FIG. 1, the image processing method of embodiments of the present disclosure includes the following processes.

At S102, a to-be-processed image is obtained, where white balance correction has been performed on the to-be-processed image.

In process S102, the to-be-processed image can be obtained. The to-be-processed image can be an image after the white balance correction. Since the collected signal of the G channel is usually strong, the R channel white balance gain and the B channel white balance gain are usually greater than 1. Thus, the R channel value and the B channel value can easily exceed the saturation pixel value after the white balance correction. Thus, the image after the white balance correction can be further processed to preserve the details of the highlighted member as much as possible.

At S104, a target image is obtained based on the to-be-processed image and is outputted.

The G channel value of a first pixel in the target image can be determined based on an R channel value and a B channel value of a second pixel in the to-be-processed image. The first pixel and the second pixel can be at a same pixel position.

In process S104, after the to-be-processed image is obtained, further processing can be performed on the to-be-processed image to obtain and output the target image. As shown in FIG. 2, for the first pixel in the target image, the G channel value of the first pixel can be determined according to the R channel value and the B channel value of the second pixel in the to-be-processed image. The first pixel and the second pixel can be at the same pixel position. For example, the first pixel can be a pixel in a first column and a first row of the target image, and the second pixel can be the pixel in a first column and a first row of the to-be-processed image.

In some embodiments, the to-be-processed image can be a demosaiced image, where the R channel value and the B channel value of the second pixel can be obtained through the demosaiced processing. In some embodiments, the to-be-processed image can be a Bayer image without demosaiced processing, the R channel value and the B channel value of the second pixel can be obtained through interpolation of the R channel value and the B channel value of a neighboring pixel of the second pixel.

The real G channel value may be over-saturated. However, the maximum pixel value outputted by the image sensor can be the saturation pixel value, i.e., the G channel value of the to-be-processed image may not be the real signal. Considering that the values of the R channel, the G channel, and the B channel of the image may have a certain correlation, the real G channel value can be restored based on the R channel value and the B channel value. Then, the member of the to-be-processed image that exceeds the saturation pixel value can be processed to obtain the target image. Thus, the detail of the highlighted member can be preserved while avoiding color distortion.

In some embodiments, there can be one or more second pixels, which can include some or all pixels in the to-be-processed image. For example, in some embodiments, the real G channel value may only need to be restored when the G channel value is saturated (i.e., the channel value being equal to the saturation pixel value) or close to the saturation pixel value. Thus, the second pixel can include a pixel with a G channel value having a difference with the saturation pixel value smaller than a predetermined difference in the to-be-processed image. the predetermined difference can be a relatively small difference that is predetermined. That is, the G channel value of the second pixel can be ensured to be equal to or very close to the saturation pixel value. For example, the G channel values that are greater than 253 can be used as the second pixel. For these pixels, since the real G channel value is likely to be over-saturated, the real G channel value can be determined based on the R channel value and the B channel value to obtain the G channel value of the first pixel in the target image. Otherwise, the G channel value of the first pixel can be determined directly based on the G channel value of the pixel in the to-be-processed image.

If the real G channel value is restored based on the R channel value and the B channel value only for some pixels of the image (e.g., the pixels with the values of the G channel being saturated or close to the saturation pixel value). Other pixels can directly use the original values of the G channel. The color of the pixels of the processed image may have an unnatural transition and banding. Thus, in some embodiments, the second pixel can be all pixels in the to-be-processed image. That is, for each pixel of the to-be-processed image, the G channel value of the target image at the corresponding pixel position can be determined according to the R channel value, the B channel value, and the G channel value. The weights of the R channel value, the B channel value, and the G channel value can be determined based on the probability of the G channel value of the pixel in the to-be-processed image being over-saturated. The banding can be avoided by performing overall processing on the to-be-processed image.

In some embodiments, when the G channel value is determined based on the R channel value and the B channel value of the second pixel in the to-be-processed image, a predicted G channel value can be determined based on the R channel value and the B channel value of the second pixel. Then, the G channel value of the first pixel can be determined based on the G channel value of the second pixel and the predicted G channel value. The predicted G channel value can be obtained based on the correlation between the values of the R channel, the G channel, and the B channel of the second pixel. The G channel value of the second pixel can be collected by the image sensor. When the G channel value of the second pixel is not saturated, the collected G channel value can be accurate. When the G channel value of the second pixel is not saturated, the collected G channel value may not be accurate (e.g., the actual pixel value can be 260, but the pixel value collected by the image sensor can be 255). The predicted value obtained based on the values of the R channel and the B channel can be accurate. Thus, the accurate real G channel value can be obtained in connection with the two manners. Thus, the G channel value of the first pixel in the target image can be determined based on the real G channel value.

In some embodiments, when the predicted G channel value is determined based on the R channel value and the B channel value of the second pixel, a first weight corresponding to the R channel value and a second weight corresponding to the B channel value of the second pixel can be determined first. Then, the R channel value and the B channel value of the second pixel can be weighted based on the first weight and the second weight to obtain the predicted G channel value. The signal of the G channel can be the strongest among the three channels. Thus, the real G channel value can be closer to a bigger one of the R channel value and the B channel value of the second pixel. Therefore, in some embodiments, when the R channel value of the second pixel is greater than the B channel value of the second pixel, the first weight can be greater than the second weight. Otherwise, the first weight can be smaller than the second weight. That is, when the predicted G channel value is determined based on the R channel value and the B channel value, the bigger one of the R channel value and the B channel value can have a larger weight.

In some embodiments, the first weight and/or the second weight can be determined based on the difference between the R channel value and the B channel value of the second pixel. In some embodiments, the first weight can be positively proportional to the difference, and the second weight can be negatively proportional to the difference. For example, assume that the R channel value is greater than the B channel value of the second pixel, when the difference between the R channel value and the B channel value is larger, the first weight corresponding to the R channel value can be larger. That is, the predicted G channel value can be closer to the R channel value. Otherwise, the principle is similar.

In some embodiments, since the probability of the real G channel value being saturated is different when the G channel value of the first pixel is determined based on the G channel value of the second pixel and the predicted G channel value, the weights of the two values can be set to be different. For example, a third weight of the predicted G channel value and a fourth weight of the G channel of the second pixel can be determined based on the RGB value of the second pixel. Then, the G channel value of the second pixel and the predicted G channel value can be weighted based on the third weight and the fourth weight to obtain the real G channel value. Then, the G channel value of the first pixel can be obtained based on the real G channel value.

If the probability of the real G channel value of the second pixel being over-saturated is larger, the predicted G channel value can be closer to the real G channel value. Thus, in some embodiments, the third weight can be positively correlated with the probability of the real G channel value of the second pixel being over-saturated. The fourth weight can be negatively correlated with the probability of the real G channel value of the second pixel being over-saturated. The probability of the real G channel value of the second pixel being over-saturated can be determined based on values of the RGB channels of the second pixel or other factors.

In some embodiments, the third weight and/or fourth weight can be determined based on at least one of the maximum value or the minimum value of the values of the R channel, the B channel, and the G channel. For example, when the maximum value is larger, the probability of the real G channel value being over-saturated can be larger. When the minimum value is larger, the probability of the real G channel value being over-saturated can also be larger.

Thus, in some embodiments, the third weight corresponding to the predicted G channel value can be positively correlated with the maximum value. The fourth weight corresponding to the G channel value of the second pixel can be negatively correlated with the maximum value.

In some embodiments, the third weight corresponding to the predicted G channel value can be positively correlated with the minimum value. The fourth weight corresponding to the G channel value of the second pixel can be negatively correlated with the minimum value.

In some embodiments, when the third weight and/or the fourth weight are determined based on the maximum value and the minimum value of the values of the R channel, the G channel, and the B channel of the second pixel, a first coefficient can be determined based on the maximum value. The first coefficient can be positively correlated with the maximum value. Then, a second coefficient can be determined based on the minimum value. The second coefficient can be positively correlated with the minimum value. Then, the third weight and/or the fourth weight can be determined based on the first coefficient and the second coefficient. For example, the product, sum, or a result through another calculation method based on the first coefficient and the second coefficient can be used as the third weight and/or the fourth weight.

If the maximum value of the values of the R channel, the G channel, and the B channel of the second pixel is smaller than the saturation pixel value, the probability of the real G channel value being over-saturated can be greatly reduced. Thus, in some embodiments, when the third weight corresponding to the predicted G channel value is determined based on the maximum value, the third weight can have a change trend. For example, when the maximum value is equal to the saturation pixel value, the third weight can be relatively large. When the maximum value is smaller than the saturation pixel value, the third weight can be quickly reduced. For example, a first slope of the first change curve of the third weight changing with the maximum value in a situation where the maximum value is smaller than the saturation pixel value is greater than a second slope of the first change curve in a situation where the maximum value is greater than the saturation pixel value. Thus, when the maximum value is less than the saturation pixel value, the third weight can exhibit a rapidly-decreasing trend.

Similarly, if the minimum value of the values of the R channel, the G channel, and the B channel of the second pixel is greater than the saturation pixel value, the probability of the real G channel value being over-saturated can be greatly improved. Thus, in some embodiments, when the third weight corresponding to the predicted G channel value is determined based on the minimum value, the third weight can have a change trend with the minimum value. For example, when the minimum value is greater than the saturation pixel value, the third weight can be increased quickly. For example, a third slope of the second change curve of the third weight changing with the minimum value in a situation where the minimum value is smaller than the saturation pixel value is smaller than a fourth slope of the second change curve in a situation where the minimum value is greater than the saturation pixel value. Thus, when the minimum value is smaller than the saturation pixel value, the third weight can exhibit a rapidly-increasing trend.

In some embodiments, when the G channel value of the first pixel in the target image is determined based on the R channel value and the B channel value of the second pixel in the to-be-processed image, the real G channel value can be determined based on the R channel value and the B channel of the second pixel. Then, the G channel value of the first pixel can be further determined based on the real G channel value. For example, to maximally preserve the details of the highlighted member, the real G channel value can be clipped to obtain the G channel value of the first pixel. For example, when the real G channel value is greater than the target threshold, the target threshold can be directly used as the G channel value of the first pixel. When the real G channel value is smaller than or equal to the target threshold, the real G channel value can be directly used as the G channel value of the first pixel.

The target threshold can be determined based on at least one of the saturation pixel value, an R channel white balance gain, or a B channel white balance gain. For example, the product of the saturation pixel value and the R channel white balance gain can be used as the target threshold, or the product of the saturation pixel value and the B channel white balance gain can be used as the target threshold to clipping the real G channel value.

When the real G channel value is determined based on the R channel value and the B channel value of the second pixel, the predicted G channel value can be determined based on the R channel value and the B channel value of the second pixel. Then, the real G channel value can be determined based on the predicted G channel value and the G channel value of the second pixel. For the specific process, reference can be made to the above embodiments of the present disclosure, which is not repeated here.

In some embodiments, after the G channel value of the first pixel of the target image is determined based on the real G channel value of the second pixel in the to-be-processed image, the R channel value of the first pixel in the target image can be determined based on the R channel value of the second pixel. The B channel value of the first pixel in the target image can be determined based on the B channel value of the second pixel. For example, the values of the R channel and the B channel of the second pixel can be directly used as the values of the R channel and the B channel of the first pixel. In some other embodiments, since the values of the R channel and the B channel can be over-saturated, the pixel value of a determined range (e.g., a range greater than half of the saturation pixel) can be compressed to cause the pixel value to be within the saturation pixel value.

In some embodiments, to preserve the details of the highlighted member as much as possible, the value of any one of the R channel and the B channel of the to-be-processed image can be clipped to obtain the value of the corresponding channel of the first pixel in the target image. For example, when the R channel value or the B channel is greater than the target threshold, the target threshold can be used as the value of the corresponding channel of the first pixel. When the R channel value or the B channel of the second pixel is smaller than the target threshold, the channel value of the second pixel can be used as the value of the corresponding channel of the first pixel.

In some embodiments, if the to-be-processed image includes a white point, for example, a center point of the sun or other types of white point, to protect the white point in the image, after restoring the real G channel value in the to-be-processed image, the values of the R channel, the G channel, and the B channel of the restored image can be clipped to the target threshold. The target threshold can be determined based on the saturation pixel value and the target white balance gain. The target white balance gain can be a smaller one of the R channel white balance gain and the B channel white balance gain. For example, the product of the saturation pixel value and the target white balance gain can be used as the target threshold.

If the to-be-processed image does not include the white point, the target threshold can be determined based on a larger one of the R channel white balance gain and the B channel white balance gain, and the saturation pixel value. For example, the product of the larger one of the R channel white balance gain and the B channel white balance gain, and the saturation pixel value can be determined as the target threshold.

The to-be-processed image with the restored G channel can be clipped to the target threshold to obtain the target image. Since pixel values of some pixels in the target image are still greater than the saturation pixel value, the pixel values in the target image can be caused to be within the saturation pixel to facilitate the subsequent processes. Before the target image is outputted, the pixel values within the determined range can be compressed in the target image. Thus, the pixel values of the pixels in the target image may not exceed the saturation pixel value. Since human eyes are sensitive to dark areas, the compressed determined range can be the range greater than half of the saturation pixel value. That is, only the pixel range above the middle gray level can be compressed.

To further describe the image processing method of embodiments of the present disclosure, some embodiments are described below.

Since the strength of the signal of the G channel is usually greater than the strengths of the signals of the R channel and the B channel, the R channel white balance gain and the B channel white balance gain are usually greater than 1, resulting in the R channel value and the B channel value of the image after the white balance processing being greater than the saturation pixel value. When the collected G channel value is saturated, to avoid the color distortion after clipping the member with the pixel value exceeding the saturation pixel value, the values of the R channel, the G channel, and the B channel can be clipped to the saturation pixel value. Thus, the details of the highlighted member of the image can be lost.

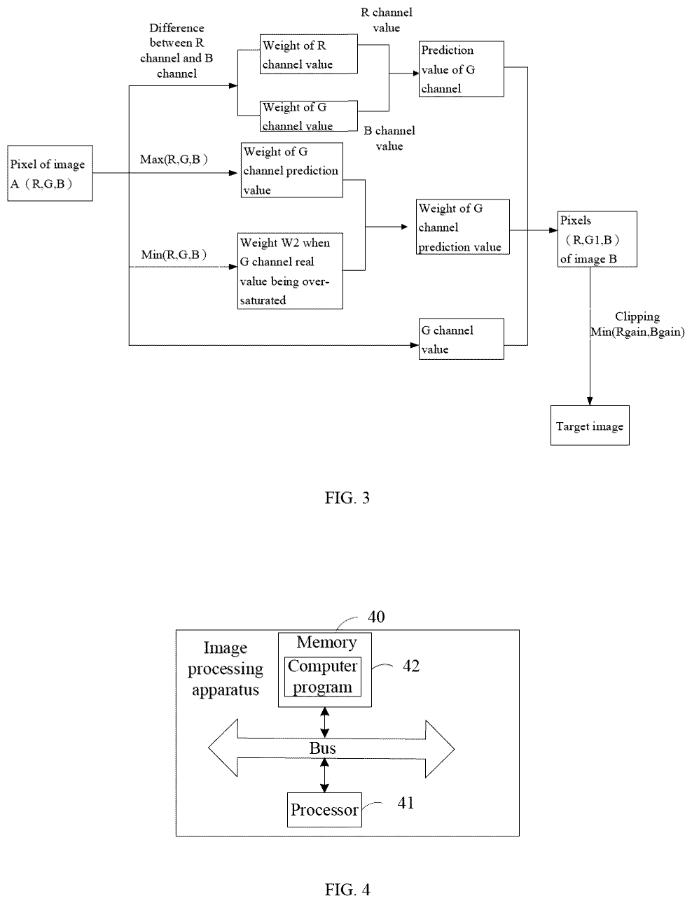

To avoid the above problem, embodiments of the present disclosure provide an image processing method, which, as shown in FIG. 3, includes the following processes.

Determination of the real G channel value.

After image A subjected to white balance correction is obtained, the real G channel value can be determined based on the values of the R channel, the G channel, and the B channel of image A for any one pixel of image A. When the G channel value is saturated, e.g., the G channel value can be 255, the real G channel value can be 255 or greater than 255. Then, the G channel value collected by the image sensor may not be the real G channel value. Since the values of the R channel, the G channel, and the B channel are often correlated, the G channel value can be reversely derived according to the R channel value and the B channel value to obtain the predicted G channel value. When the G channel value is not saturated, the G channel value collected by the image sensor can be probably accurate. That is, the collected G channel value can be the real G channel value. Based on this, for any one pixel of image A, the real G channel value of the pixel can be determined in connection with the G channel value and the predicted G channel value that is reversely derived according to the values of the R channel and the B channel. Determining the real G channel value can include the following processes.

The predicted G channel value is determined based on the values of the R channel and the B channel.

Since the signal of the G channel is usually greater than the signals of the R channel and the B channel, the G channel value can be closer to one stronger signal of the signals of the R channel and the B channel. Thus, the weights of the values of the R channel and the B channel can be determined based on the difference between the values of the R channel and the B channel. For example, when the R channel value is greater than the B channel value, the larger the difference between the R channel value and the B channel value is, the larger the weight of the R channel value is, and the smaller the weight of the B channel value is, vice versa. After the values of the R channel and the B channel are determined, the predicted G channel value can be determined based on the weights and the values of the R channel and the B channel.

Weights of the collected G channel value and the predicted G channel value are determined, and the real value (G1) of the G channel is determined based on the weights.

When the probability of the G channel value of the pixel being over-saturated (i.e., greater than the saturation pixel value) is larger, the weight of the predicted G channel value can be larger when the real G channel value is calculated. The weight of the predicted G channel value can be determined based on the maximum value and the minimum value of the values of the R channel, the G channel, and the B channel. For example, when the maximum value is greater than the saturation pixel value, the probability of the G channel value of the pixel being over-saturated can be relatively large. When the maximum value is smaller than the saturation pixel value, the probability of the G channel value of the pixel being over-saturated can be rapidly reduced.

Similarly, for the smallest value of the three channels of the pixel, if the minimum value is greater than the saturation value, the probability of the pixel being over-saturated can be relatively large, otherwise small.

Weight w1 corresponding to the predicted G channel value can be determined based on the maximum value. Weight w2 corresponding to the predicted G channel value can be determined based on the minimum value. Then, probability W of the predicted G channel value can be obtained based on w1 and w2. The weight corresponding to the collected G channel value can be 1−W. Thus, real value G1 of the G channel can be determined based on the weights of the predicted G channel value and the values of the G channel.

The white point is protected.

After real value G1 of the G channel is obtained, i.e., real value G1 of the G channel can be used to replace the G channel value in image A to obtain image B with the restored G channel value. When image B does not include the white point, the clipping value can be determined directly according to a larger one of the R channel white balance gain (Rgain) and the B channel white balance gain (Bgain). For example, the R channel white balance gain can be 1.2, the B channel white balance gain can be 1.1, and the clipping value can be 1.2×the saturation pixel value. Then, the value of the values of the R channel, the G channel, and the B channel that is greater than the clipping value can be replaced by the clipping value.

The image can include a white point, for example, the center position of the sun can be white, or other types of white points. If the clipping value is determined according to a larger one of the R channel white balance gain and the B channel white balance gain, the white point in the image that is clipped may not be white, and the color may be distorted. To avoid color distortion, the white point of the image can be protected. The clipping value can be determined according to a smaller one of the R channel white balance gain and the B channel white balance gain. Then, the value of the values of the R channel, the G channel, and the G channel in image B that is greater than the clipping value can be replaced by the clipping value. For example, the R channel white balance gain can be 1.2, the B channel white balance gain can be 1.1, and the clipping value can be 1.1×the saturation pixel value.

The real G channel value of the pixel that is saturated at the G channel in the image can be restored according to the R channel value and the B channel value. Then, the details of the highlighted member in the image can be preserved. After the real G channel value is restored, the clipping value can be determined according to the smaller one of the R channel white balance gain and the B channel white balance gain. The values of the R channel, the G channel, and the B channel can be clipped to the clipping value to protect the white point in the image.

Since the pixel values of some pixels in the clipped image are greater than the saturation pixel value, to control the pixel value of the pixels of the image to be within the saturation pixel value, the value of the values of the channels in the image that is greater than the half of the saturation pixel value can be compressed to cause the value to be within the saturation pixel value.

When there is no conflict, method embodiments can be combined with each other, which are not described one by one.

Corresponding to the method, embodiments of the present disclosure provide an image processing apparatus 40. As shown in FIG. 4, the image processing apparatus 40 includes one or more processors 41 and one or more memories 42, and one or more computer programs are stored in the one or more memories 42 for the one or more processors 41 to execute. When the one or more processors 41 execute the computer program, the following processes can be realized.

The to-be-processed image is obtained. The to-be-processed image is subjected to the white balance correction.

The target image is obtained and outputted based on the to-be-processed image.

The G channel value of the first pixel in the target image can be determined based on the R channel value and the B channel value of the second pixel in the to-be-processed image. The first pixel and the second pixel can be at the same pixel position.

In some embodiments, the difference between the G channel value of the second pixel and the saturation pixel value can be smaller than the predetermined difference.

In some embodiments, determining the G channel value of the first pixel based on the R channel value and the B channel value of the second pixel in the to-be-processed image can include determining the predicted G channel value based on the R channel value and the B channel value of the second pixel and determining the G channel value of the first pixel based on the G channel value of the second pixel and the predicted G channel value.

In some embodiments, determining the predicted G channel value based on the R channel value and the B channel value of the second pixel can include determining the first weight of the R channel value of the second pixel and the second weight of the B channel value of the second pixel based on the R channel value and the B channel value of the second pixel and weighting the R channel value and the B channel value of the second pixel based on the first weight and the second weight to obtain the predicted G channel value.

In some embodiments, when the R channel value of the second pixel is greater than the B channel value of the second pixel, the first weight can be greater than the second weight. Otherwise, the first weight can be smaller than the second weight.

In some embodiments, the first weight and/or the second weight can be determined based on the difference between the R channel value and the B channel value of the second pixel.

In some embodiments, the first weight can be positively correlated to the difference, and the second weight can be negatively correlated to the difference.

In some embodiments, determining the G channel value of the first pixel based on the G channel value of the second pixel and the predicted G channel value can include determining the third weight of the predicted G channel value and the fourth weight of the G channel value of the second pixel based on the RGB value of the second pixel and weighting the G channel value of the second pixel and the predicted G channel value based on the third weight and the fourth weight to obtain the G channel value of the first pixel.

In some embodiments, the third weight can be positively correlated to the probability of the real G channel value of the second pixel being greater than the saturation pixel value, and the fourth weight can be negatively correlated to the probability.

In some embodiments, the third weight and/or the fourth weight can be determined based on at least one of the maximum value of the values of the R channel, the G channel, and the B channel of the second pixel, or the minimum value of the values of the R channel, the G channel, and the B channel of the second pixel.

In some embodiments, the third weight can be positively correlated to the maximum value, and the fourth weight can be negatively correlated to the maximum value.

In some embodiments, the third weight can be positively correlated to the minimum value, and the fourth weight can be negatively correlated to the minimum value.

In some embodiments, determining the third weight and/or the fourth weight based on at least one of the maximum value of the values of the R channel, the G channel, and the B channel of the second pixel, or the minimum value of the values of the R channel, the G channel, and the B channel of the second pixel can include determining the first coefficient based on the maximum value, the first coefficient being positively correlated to the maximum value, determining the second coefficient based on the minimum value, the second coefficient being positively correlated to the minimum value, and determining the third weight and/or the fourth weight based on the first coefficient and the second coefficient.

In some embodiments, a first slope of a first change curve of the first weight changing with the maximum value in a situation where the maximum value is smaller than the saturation pixel value is greater than a second slope of the first change curve in a situation where the maximum value is greater than the saturation pixel value.

In some other embodiments, a third slope of a second change curve of the first weight changing with the minimum value in a situation where the minimum value is smaller than the saturation pixel value is smaller than a fourth slope of the second change curve in a situation where the minimum value is greater than the saturation pixel value.

In some embodiments, determining the G channel value of the first pixel in the target image based on the R channel value and the B channel value of the second pixel in the to-be-processed image can include determining the real G channel value based on the R channel value and the B channel value of the second pixel in the to-be-processed image, when the real G channel value is greater than the target threshold, using the target threshold as the G channel value of the first pixel, and when the real G channel value is smaller than the target threshold, using the real G channel value as the G channel value of the first pixel.

In some embodiments, the target threshold can be determined based on the saturation pixel value and the target white balance gain. The target white balance gain can be a smaller one of the R channel white balance gain and the B channel white balance gain.

In some embodiments, for any one channel of the R channel and the B channel, when the channel value of the second pixel is greater than the target threshold, the target threshold can be used as the channel value of the first pixel.

When the channel value of the second pixel is smaller than the target threshold, the channel value of the second pixel can be used as the channel value of the first pixel.

In some embodiments, before outputting the target image, the processor can be further configured to compress the pixel value of the determined range in the target image to cause the pixel value of the pixel in the target image to not exceed the saturation pixel value. The determined range can refer to the range greater than half of the saturation pixel value.

Correspondingly, embodiments of the present disclosure further provide a computer-readable storage medium. The storage medium can store a program that, when executed by the processor, causes the processor to realize the method of any one of embodiments of the present disclosure.

Embodiments of the present disclosure can adopt a computer program product implemented in one or more storage media (including but not limited to disk storage, CD-ROM, optical storage, etc.) including program codes. The computer-readable storage media can include volatile and non-volatile, and removable and non-removable media. The information storage can be realized in any method or technology. Information can include computer-readable instructions, data structures, program modules, or other data. Examples of the computer storage media can include but are not limited to phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, CD-ROM, digital versatile disks (DVD) or other optical storage, magnetic cassettes, magnetic tapes, magnetic disk storage, or other magnetic storage devices, or any other non-transitory medium that can be used to store information accessible by a computing device.

Since apparatus embodiments basically correspond to the method embodiments, relevant details can be referred to the description of the method embodiments. The apparatus embodiments described above are merely illustrative. The units described as separate members can be physically separated or not. The member shown as a unit can be a physical unit or not. That is, the member can be located in one place or distributed across a plurality of network units. Some or all of the modules can be selected to realize the purposes of embodiments of the present disclosure as needed. Those ordinary skills in the art can understand and implement the technical solution without creative efforts.

In the present disclosure, the relational terms such as “first” and “second” are only used to distinguish one entity or operation from another entity or operation and do not necessarily require or imply any such actual relationship or order between these entities or operations. The terms “include,” “comprise,” or any other variants are intended to cover non-exclusive inclusion, so that a process, method, article, or device that includes a series of elements not only includes those elements but also other elements not explicitly listed or elements inherent to such process, method, article, or device. Without further limitation, an element defined by the phrase “including a . . . ” does not exclude the presence of additional identical elements in the process, method, article, or device that includes the element.

The methods and the apparatus of embodiments of the present disclosure are described in detail above. The principle and implementation of the present disclosure are described with specific examples. The description of embodiments of the present disclosure are only used to help with the understanding of the methods and core concepts of the present disclosure. Meanwhile, for those ordinary skills in the art, changes can be made to the application scope of embodiments of the present disclosure according to the concept of the present disclosure. In summary, the content of the present specification cannot be considered as a limitation of the present disclosure.

What is claimed is:

1. An image processing method comprising:
obtaining a to-be-processed image, the to-be-processed image having been subjected to white balance correction;
obtaining a target image based on the to-be-processed image, including:
determining a G channel value of a first pixel in the target image based on an R channel value and a B channel value of a second pixel in the to-be-processed image, the first pixel and the second pixel being at a same pixel position; and
outputting the target image.

2. The method according to claim 1, wherein a difference between a G channel value of the second pixel and a saturation pixel value is smaller than a predetermined difference.

3. The method according to claim 1, wherein determining the G channel value of the first pixel includes:
determining a predicted G channel value based on the R channel value and the B channel value of the second pixel; and
determining the G channel value of the first pixel based on a G channel value of the second pixel and the predicted G channel value.

4. The method according to claim 3, wherein determining the predicted G channel value includes:
determining a first weight of the R channel value of the second pixel and a second weight of the B channel value of the second pixel based on the R channel value and the B channel value of the second pixel; and
weighting the R channel value and the B channel value of the second pixel based on the first weight and the second weight to obtain the predicted G channel value.

5. The method according to claim 4, wherein:
the first weight is determined to be greater than the second weight in response to the R channel value of the second pixel being greater than the B channel value of the second pixel; and
the first weight is determined to be smaller than the second weight in response to the R channel value of the second pixel being smaller than the B channel value of the second pixel.

6. The method according to claim 4, wherein at least one of the first weight or the second weight is determined based on a difference between the R channel value of the second pixel and the B channel value of the second pixel.

7. The method according to claim 6, wherein the first weight is positively correlated to the difference, and the second weight is negatively correlated to the difference.

8. The method according to claim 3, wherein determining the G channel value of the first pixel includes:
determining a first weight of the predicted G channel value and a second weight of the G channel value of the second pixel based on RGB values of the second pixel; and
weighting the G channel value of the second pixel and the predicted G channel value based on the first weight and the second weight to obtain the G channel value of the first pixel.

9. The method according to claim 8, wherein:
the first weight is positively correlated to a probability of a real G channel value of the second pixel being greater than the saturation pixel; and
the second weight is negatively correlated to the probability.

10. The method according to claim 8, wherein at least one of the first weight or the second weight is determined based on at least one of a maximum one or a minimum one of the R channel value, the G channel value, and the B channel value of the second pixel.

11. The method according to claim 10, wherein the first weight is positively correlated to the maximum value, and the second weight is negatively correlated to the maximum value.

12. The method according to claim 10, wherein the first weight is positively correlated to the minimum value, and the second weight is negatively correlated to the minimum value.

13. The method according to claim 10, wherein determining the at least one of the third weight or the fourth weight includes:
determining a first coefficient based on the maximum value, the first coefficient being positively correlated with the maximum value;
determining a second coefficient based on the minimum value, the second coefficient being positively correlated with the minimum value; and
determining the at least one of the first weight or the second weight based on the first coefficient and the second coefficient.

14. The method according to claim 10, wherein:
a first slope of a first change curve of the first weight changing with the maximum value in a situation where the maximum value is smaller than the saturation pixel value is greater than a second slope of the first change curve in a situation where the maximum value is greater than the saturation pixel value; and/or
a third slope of a second change curve of the first weight changing with the minimum value in a situation where the minimum value is smaller than the saturation pixel value is smaller than a fourth slope of the second change curve in a situation where the minimum value is greater than the saturation pixel value.

15. The method according to claim 1, wherein determining the G channel value of the first pixel includes:
determining a real G channel value based on the R channel value and the B channel value of the second pixel;
in response to the real G channel value being greater than a target threshold, determining the target threshold as the G channel value of the first pixel; and
in response to the real G channel value being smaller than the target threshold, determining the real G channel value as the G channel value of the first pixel.

16. The method according to claim 15, wherein:
the target threshold is determined based on a saturation pixel value and a target white balance gain; and
the target white balance gain is a smaller one of an R channel white balance gain and a B channel white balance gain.

17. The method according to claim 15, wherein for either of the R channel and the B channel:
in response to a channel value of the second pixel being greater than the target threshold, using the target threshold as the channel value of the first pixel; and
in response to the channel value of the second pixel being smaller than the target threshold, using the channel value of the second pixel as the channel value of the first pixel.

18. The method according to claim 1, further comprising, before outputting the target image:
compressing pixel values of a determined range in the target image to cause pixel values of pixels in the target image to not exceed a saturation value, the determined range being a range greater than half of a saturation pixel value.

19. An image processing apparatus comprising:
one or more processors; and
one or more memories storing a computer program that, when performed by the one or more processors, causes the one or more processors to:
obtain the to-be-processed image, the to-be-processed image having been subjected to white balance correction;
obtain a target image based on the to-be-processed image, including:
determining a G channel value of a first pixel in the target image based on an R channel value and a B channel value of a second pixel in the to-be-processed image, the first pixel and the second pixel being at a same pixel position; and
output the target image.

20. An image processing method comprising:
obtaining a to-be-processed image, the to-be-processed image having been subjected to white balance correction;
obtaining a target image based on the to-be-processed image, wherein a G channel value of a pixel in the target image is determined from an R channel value and a B channel value of a pixel at the same pixel position in the target image; and
outputting the target image.
